(19) United States
(12) Patent Application Publication
(10) Pub. No.: US 2008/0023082 A1
(43) Pub. Date: Jan. 31, 2008

(54) Device For Conveying Viscous Material

(76) Inventor: Josef Schucker, Karlsruhe (DE)

Correspondence Address: WILLIAM COLLARD;COLLARD & ROE, P.C., 1077 NORTHERN BOULEVARD, ROSLYN, NY, 11576, US

(21) Appl. No.: 11/630,432

(22) PCT Filed: Jun. 15, 2005
(86) PCT No.: PCT/EP05/06392

§ 371 Date: Dec. 21, 2006

(30) Foreign Application Priority Data
Jun. 24, 2004 (DE) 102004030654.0

(51) Int. Cl. B67D 5/02

(52) U.S. Cl. 137/565.17

(57) ABSTRACT

The invention relates to a device for conveying viscous material from a barrel-type container, which consists of a container bottom and a container wall, by means of a conveyor pump, being provided with a follow-up plate which is used to seal the container and which comprises a material outlet that is connected to a conveyor pump and which is arranged on the inner surface of the container wall facing the inside of the container, being moveable in the direction of the container bottom. The material outlet on the lower side of the follow-up plate facing the inside of the container comprises a funnel. According to the invention, the follow-up plate comprises a cover element which covers the funnel and is provided with continuous openings for the viscous material.

The invention relates to a device for conveying viscous material, in accordance with the preamble of claim 1, or in accordance with the preamble of claim 9, respectively.

Such devices serve for conveying viscous material, particularly adhesives or sealants, from a barrel to a processing station. The follow-up plate affixed to a frame lies against the surface of the material situated in the barrel, and follows this surface as the material level decreases. The material is removed from the barrel by means of a pump, whereby the follow-up plate follows the material surface. However, it is also possible that the follow-up plate presses onto the material surface, so that the material is pressed into the material outlet as a result of this pressure. A fixed switch is disposed on a rack that carries the frame, which switch is activated when a part disposed on the frame is moved past it. This movable part is disposed at a predetermined distance from the underside of the follow-up plate, so that triggering of the switch indicates arrival of the follow-up plate at the bottom of the container, and therefore that the barrel is empty, and shuts off the drive device of the follow-up plate as well as the pump. For the sake of safety, the movable part is disposed at such a distance from the follow-up plate that the switch is generally triggered while there is still a residual amount of material in the barrel. This is due to the fact that it must absolutely be avoided that the pump continues to run if the barrel is already completely empty. In this case, ambient air would be drawn in, because of the partial vacuum occurring in the barrel, and if this air were to reach the pump, complicated cleaning would be required. By switching off the pump and stopping the follow-up plate at a safety distance from the bottom of the barrel, the result is achieved that even if there are slight deviations in the barrel dimensions, contact of the follow-up plate with the bottom of the barrel is prevented. After the barrel has been emptied, the follow-up plate is lifted off from the barrel, and the residual material that has not been removed from the barrel remains in the barrel. This material cannot be introduced into the production process. More than that, however, these are usually environmentally harmful substances, so that the residue remaining in the barrel must be disposed of as hazardous waste, and this is expensive.

In order to guarantee better introduction of the material into the material outlet, the follow-up plate has a funnel on its underside, which narrows in the direction towards the material outlet. Even if it is possible to lower the follow-up plate all the way to the bottom of the container without drawing air into the barrel, the residual material that remains in the funnel after the pump is shut off remains in the barrel. When the follow-up plate is lifted off the emptied barrel during a change in barrels, this residue remains adhering to the bottom of the barrel.

It is therefore the task of the invention to further develop a device of the type stated initially, in such a manner that it allows better utilization of the material contained in the barrel.

This task is accomplished, according to the invention, by means of a device having the characteristics of claim 1, and a device having the characteristics of claim 9, respectively. Advantageous further developments of the invention are the object of the dependent claims.

The invention is based on the idea that at least part of the material residue contained in the funnel remains in the latter when the follow-up plate is lifted off from the emptied container, because of the cover element that covers the funnel, and does not remain adhering to the bottom of the container. When the follow-up plate is set onto the next, full container, the material remaining in the funnel is utilized and does not have to be disposed off. In this connection, the size of the passage openings in the cover element is dependent on the viscosity of the material. Large passage openings are required for highly viscous material, in order to ensure passage of the viscous adhesive or sealant during conveying. If the material has low viscosity, material passage is also possible if the passage openings are smaller. Vice versa, the passage openings must be smaller in the case of low-viscosity material, in order to hold the material in the funnel when the follow-up plate is lifted off.

It is practical if the cover element is a grid that spans the funnel. This preferably has a central ring and arms extended from the ring in the radial direction, for attachment to the follow-up plate. This is particularly advantageous if the conveyor pump has a scooping piston that projects into the funnel and can move up and down, which can submerge into the ring during the scooping movement. Alternatively it is possible, particularly for low-viscosity materials, to implement the cover element as a perforated plate.

It is preferred that the cover element ends flush with a surface on the underside of the follow-up plate that lies against the viscous material. In this way, the greatest possible proportion of the amount of material contained in the funnel is retained when the follow-up plate is lifted off. It is practical if the cover element is releasably attached to the follow-up plate, so that it can be removed for cleaning purposes or replaced with another cover element.

Alternatively or supplemental to the measures described above, the follow-up plate can have a distance sensor for measuring the distance from the bottom of the container. This aspect of the invention is based on the idea of being able to measure the distance of the follow-up plate from the bottom of the container directly, thereby achieving greater accuracy. This has the advantage, as compared with the indirect distance measuring method known from the state of the art, that the follow-up plate can be brought closer to the bottom of the container before the pump is switched off, since the safety distance that balances out measurement inaccuracies can be sized smaller, or can be eliminated entirely. The material residue remaining in the container then becomes smaller than in the case of known conveyance devices.

The distance sensor can have a pin that projects out of the follow-up plate, which pin can be moved against a reset force, to trigger a signal, upon contact with the bottom of the container. When the follow-up plate approaches the bottom of the container, the pin is pressed into the plate against the reset force, so that a signal that characterizes that a minimum distance has been reached is triggered. However, it is preferred that the distance sensor has at least one proximity switch for triggering a signal if the distance from the bottom of the container reaches or goes below a predetermined value. If the bottom of the container consists at least in part of metal, it is particularly preferred that the distance sensor has at least one inductive proximity switch for triggering the signal when the bottom of the container is approached.

It is practical if the follow-up plate can be moved by means of a drive device that is shut off when the signal is triggered. Furthermore, it is practical if the conveyor pump is deactivated by means of the signal. Ideally, the predetermined distance is zero, so that the drive device and the conveyor pump can be shut off precisely when the follow-up plate rests against the bottom of the container and there is no material or only a small amount of material between the follow-up plate and the bottom of the container.

Preferably, the distance sensor is inserted into a recess of the follow-up plate that is open towards the interior of the container. It is practical if the distance sensor is inserted into a plastic sleeve that has a sleeve bottom that faces the interior of the container. This is particularly advantageous if the distance sensor has an inductive proximity switch whose method of effect is not impaired by the sleeve bottom made of plastic.

It is advantageous if the distance sensor has another pin or another, preferably inductive proximity switch for triggering another signal when the distance from the bottom of the container reaches or goes below a predetermined value. Both alternatives are particularly advantageous if the conveyor device is part of a processing device for the viscous material, which has at least one other similar conveyor device and a feed line for supplying the viscous material to a processing station, whereby the feed line can optionally be connected with the conveyor pump of one of the conveyor devices. It is practical if both conveyor devices each have a heating device for heating the viscous material, so that its flow properties are improved. In this connection, it is particularly advantageous that the heating device of one of the conveyor devices can be activated by means of a signal of the distance sensor of the other conveyor device that characterizes that the distance has reached or gone below a predetermined value. In this connection, the additional predetermined distance is sized in such a manner that the one conveyor device has reached its operating temperature, as the result of the heating process, at the time that the container at the other conveyor device has been emptied.

In the following, the invention will be explained in greater detail using an exemplary embodiment schematically shown in the drawing. This shows:

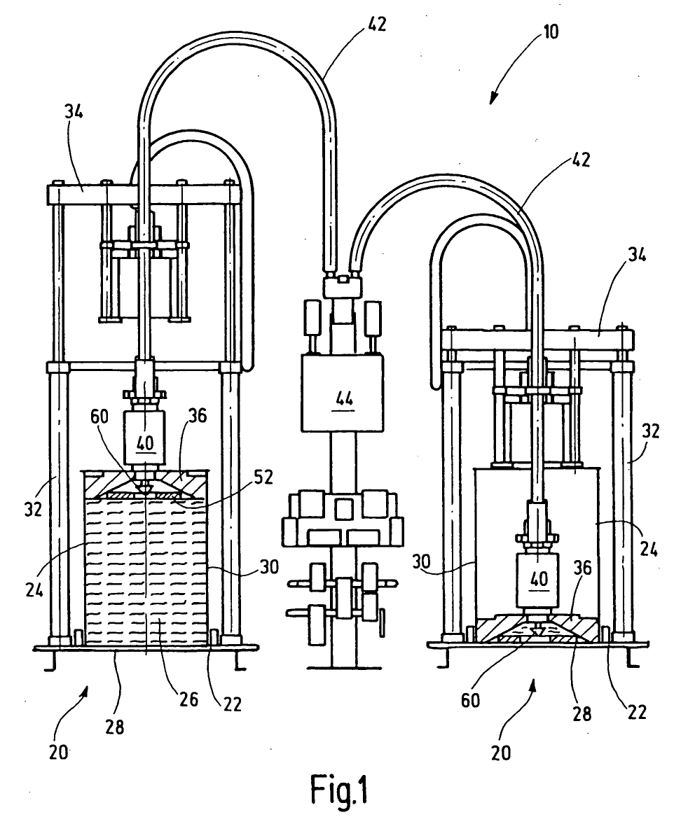

FIG. 1 a schematic representation of a processing device having two devices for conveying viscous material, partially in section;

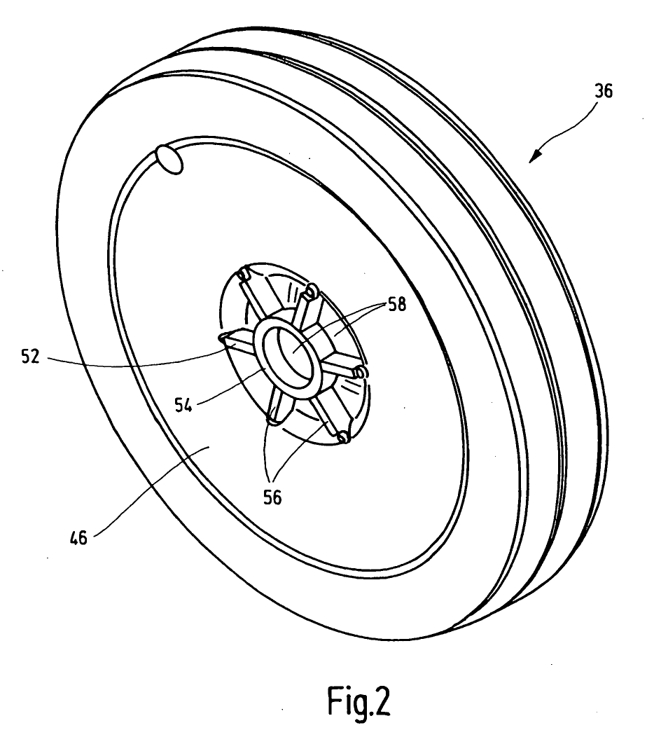

FIG. 2 a perspective view of a follow-up plate at a slant from below, and

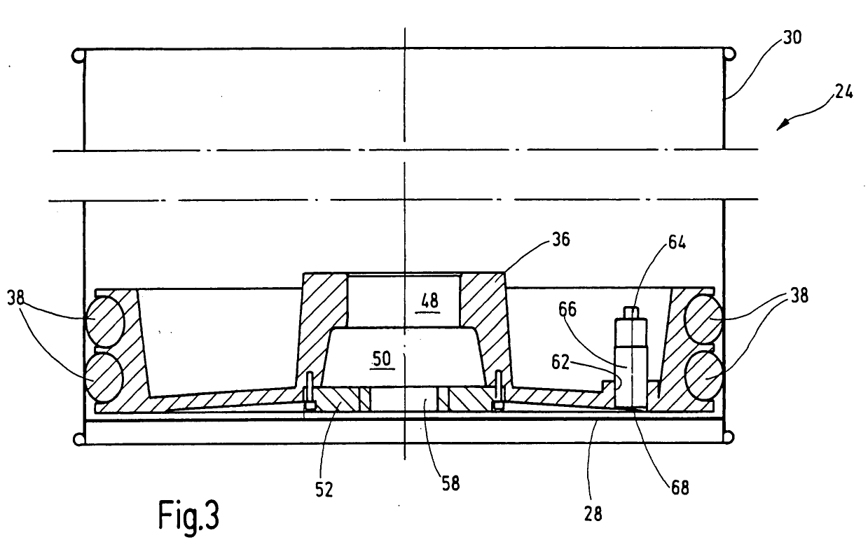

FIG. 3 a section through a container having a follow-up plate.

A processing machine 10 for viscous materials, such as adhesives or sealants, has two conveyor devices 20 for the viscous material, according to FIG. 1. The conveyor devices 20 each have a set-down surface 22 for a barrel 24, in which the viscous material 26 is contained. Each barrel 24 has a bottom 28 and a barrel wall 30 that extends upward from the bottom 28. A rack 32 extends upward from the set-down surface 22, to which rack a frame 34 that is vertically displaceable by means of a drive device is attached. A follow-up plate 36 is connected with the vertically movable frame 34, which plate is set onto the barrel 24 in order to empty it, and is provided with seals 38 that lie against the inside of the barrel wall 30. Above the follow-up plate 36, a conveyor pump 40 for the viscous material 26 is disposed, which pumps the viscous material 26 to a distributor station 44 by way of a hose line 42, from which station it is guided to a processing station by way of a feed line. In this connection, one of the conveyor pumps 40 is always in operation, while the other is stopped in stand-by mode.

A material outlet 48 for the viscous material 26, disposed on the underside 46 of the follow-up plate 36, is connected with the conveyor pump 40. This outlet opens into a funnel 50, on the underside 46, which funnel is covered by a cover element 52. The cover element 52 is implemented as a grid that has a central ring 54 and arms 56 that extend from the ring in the radial direction. The grid 52 is screwed onto the follow-up plate 36 at the arms 56, and ends flush with the underside 46. Passage openings 58 for the viscous material 26 remain free between the ring 54 and the arms 56. The conveyor pump 40 has a scooping piston 60 that submerges into the ring 54 during pump operation.

During emptying of the barrel 24, the follow-up plate 36 follows the material level, which decreases over time. In this connection, it lies against the surface of the material 26 with its underside 46. When the barrel 24 is empty, the conveyor pump 40 is shut off, in order to prevent air from being drawn into the hose line 42 by way of the gap between the follow-up plate 36 and the barrel wall 30. The follow-up plate 36 is lifted off from the emptied barrel 24, whereby the residual material remaining in the funnel 50 is prevented from adhering to the bottom 28 of the barrel by means of the cover element 52. The follow-up plate 36 is set onto a new, full barrel, so that the residual material contained in the funnel 50 is first conveyed by the conveyor pump when the latter is started up again.

A distance sensor 64 is inserted into a recess 62 that is open towards the underside 46 of the follow-up plate 36, which sensor is implemented as an inductive proximity switch. The distance sensor 64 is inserted into a plastic sleeve 66, the sleeve bottom 68 of which is in contact with the viscous material 26 during the pumping process. The distance sensor 64 measures the distance of the follow-up plate 36 from the metal barrel bottom 28. Two predetermined distances are stored in the memory of evaluation electronics. If the distance sensor 64 measures that the first distance of the follow-up plate 36 from the barrel bottom 28 has reached or gone below a predetermined value, a heating device is turned on at the other conveyor device 20, which heating device heats the conveyor pump 40 and the follow-up plate 36 of the other conveyor device 20. This preheating process serves to reduce the viscosity of the material 26 in a new, full barrel, in order to facilitate the pumping process. In this connection, the first predetermined distance is sized in such a manner that the barrel 24 of the one conveyor device 20 is emptied precisely when the preheating process of the other conveyor device 20 has been concluded, and material can be conveyed out of the full barrel.

The second predetermined distance signals that the follow-up plate 36 has reached the barrel bottom 28 and that the barrel 24 is empty. At this moment, the conveyor pump 40 must be shut off and the follow-up plate 36 must be stopped. By means of the direct measurement of the distance between the follow-up plate 36 and the barrel bottom 28, the follow-up plate 36 can be brought to the barrel bottom 28 with great precision, so that less residual material remains in the emptied barrel, as compared with conventional conveyor devices, in which a safety distance must be maintained between follow-up plate and barrel bottom.

In summary, the following should be stated:

The invention relates to a device for conveying viscous material 26 out of a barrel-like container 24 having a container bottom 28 and a container wall 30, having a follow-up plate 36 having a material outlet 48 connected with a conveyor pump 40, for closing the container 24, which plate is movable in the direction towards the container bottom 28, resting against the inside surface of the container wall 30 that faces the interior of the container, whereby the material outlet 48 has a funnel 50 on the underside 46 of the follow-up plate 36, facing the interior of the container. According to the invention, the follow-up plate 36 has a cover element 52 that covers the funnel 50, having passage openings 58 for the viscous material 26.

1: Device for conveying viscous adhesive or jointing materials (26) out of a barrel-like container (24) having a container bottom (28) and a container wall (30), having a follow-up plate (36) having a material outlet (48) connected with a conveyor pump (40), for closing the container (24), which plate is movable in the direction towards the container bottom (28), resting against the inside surface of the container wall (30) that faces the interior of the container, whereby the material outlet (48) has a funnel (50) on the underside (46) of the follow-up plate (36), facing the interior of the container, wherein the follow-up plate (36) has a cover element (52) that covers the funnel (50), having passage openings (58) for the viscous material (26).

2: Device according to claim 1, wherein the cover element (52) is a grid that spans the funnel (50).

3: Device according to claim 2, wherein the grid has a central ring (54) arms (56) extending from the ring (54) in the radial direction, for attachment to the follow-up plate (36).

4: Device according to claim 3, wherein the conveyor pump (40) has a scooping piston (60) that projects into the funnel (50) and can move up and down, which submerges into the ring (54) during the scooping movement.

5: Device according to claim 1, wherein the cover element (52) is a perforated plate.

6: Device according to claim 1, wherein the cover element (52) ends flush with a surface on the underside (46) of the follow-up plate (36) that lies against the viscous material (26).

7: Device according to claim 1, wherein the cover element (52) is releasably attached to the follow-up plate (36).

8: Device according to claim 1, wherein the follow-up plate (36) has a distance sensor (64) for measuring the distance from the container bottom (28).

9: Device for conveying viscous adhesive or jointing materials (26) out of a barrel-like container (24) having a container bottom (28) and a container wall (30), having a follow-up plate (36) having a material outlet (48) connected with a conveyor pump (40), for closing the container (24), which plate is movable in the direction towards the container bottom (28), resting against the inside surface of the container wall (30) that faces the interior of the container, wherein the follow-up plate (36) has a distance sensor (64) for measuring the distance from the container bottom (28).

10: Device according to claim 8, wherein the distance sensor (64) has a pin that projects out of the follow-up plate (36), which pin can be moved against a reset force, to trigger a signal, when the distance from the container bottom (28) reaches or goes below a predetermined value, by means of contact with the container bottom (28).

11: Device according to claim 8, wherein the distance sensor (64) has at least one proximity switch for triggering a signal if the distance from the container bottom (28) reaches or goes below a predetermined value.

12: Device according to claim 11, wherein the container bottom (28) consists at least in part of metal, and that the distance sensor (64) has at least one inductive proximity switch for triggering the signal when the container bottom (28) is approached.

13: Device according to claim 10, wherein the follow-up plate (36) can be moved by means of a drive device that is shut off when the signal is triggered.

14: Device according to claim 10, wherein the conveyor pump (40) can be deactivated by means of the signal.

15: Device according to claim 8, wherein the distance sensor (64) is inserted into a recess (62) in the follow-up plate (36) that is open towards the interior of the container.

16: Device according to claim 15, wherein the distance sensor (64) is inserted into a plastic sleeve (66) that has a sleeve bottom (68) that faces the interior of the container.

17: Device according to claim 10, wherein the distance sensor (64) has another pin or another, preferably inductive proximity switch for triggering another signal when the distance from the container bottom (28) reaches or goes below a predetermined value.

18: Device according to claim 10, wherein the pin or the proximity switch triggers another signal when the distance from the container bottom (28) reaches or goes below a predetermined value.

19: Processing device for viscous material, having at least two conveyor devices (20) according to claim 8, and having a feed line for supplying the viscous material (26) to a processing station, whereby the feed line can optionally be connected with the conveyor pump (40) of one of the conveyor devices.

20: Processing device according to claim 19, wherein the conveyor devices (20) each have a heating device for heating the viscous material (26).

21: Processing device according to claim 20, wherein the heating device of one of the conveyor devices (20) can be activated by means of a signal of the distance sensor (64) of the other conveyor device that characterizes that the distance has reached or gone below a predetermined value.
